(19) United States
(12) Patent Application Publication
(10) Pub. No.: US 2021/0163160 A1
(43) Pub. Date: Jun. 3, 2021

(54) PACKAGING SYSTEM FOR PRODUCING POUCHES

(71) Applicant: EME Engel Machinefabriek En Engineering B.V., Zaandam (NL)

(72) Inventors: Arie BOOD, Zaandam (NL); Marc Robert WIJNBERG, Zaandam (NL)

(21) Appl. No.: 16/604,747

(22) PCT Filed: Apr. 10, 2018
(86) PCT No.: PCT/NL2018/050221

§ 371 Date: Oct. 11, 2019

(30) Foreign Application Priority Data
Apr. 13, 2017 (NL) 2018707

(51) Int. Cl. B65B 9/04; B65B 37/08; B65B 37/20; B65B 47/10

(52) U.S. Cl. CPC B65B 9/042; B65B 37/08; B65B 2230/02; B65B 47/10; B65B 2009/047; B65B 37/20

(57) ABSTRACT

A packaging system (1) for producing pouches having multiple compartments and made from a first water-soluble foil (5) and a second water-soluble foil (6), which packaging system (1) comprises a mould conveyor (7) to move multiple moulds (8) in a conveying direction (9) along an endless trajectory, a suction device (14) configured to suck the first foil into the first suction chambers (11) and the second suction chambers (12), a first foil supplying device (16), a powder filling device (25) configured to fill the first compartment with a powder in an accurate manner, a further filling device (28) configured to fill the second compartment with a further powder or a liquid, and a second foil supplying device (17).

### FIELD OF THE INVENTION

The invention relates to a packaging system for producing pouches having a compartment and made from a first water-soluble foil and a second water-soluble foil.

### BACKGROUND OF THE INVENTION

The invention is based on the insight that the known packaging systems are not able produce high quality pouches holding different materials.

### SUMMARY OF THE INVENTION

The invention has the objective to provide an improved or alternative packaging system. This objective is reached by a packaging system for producing pouches having multiple compartments and made from a first water-soluble foil and a second water-soluble foil, which packaging system comprises;
a mould conveyor to move multiple moulds in a conveying direction along an endless trajectory, such as a circular trajectory, wherein each mould faces outwards and has a first suction chamber, a second suction chamber, and a support surface surrounding and extending between the first and second suction chamber,
a suction device configured to suck the first foil into the first suction chambers and the second suction chambers, and wherein the mould conveyor moves each mould along;
   a first foil supplying device configured to position the first foil on the support surface of the mould and over its first and second suction chamber, after which the suction device sucks a first part of the first foil extending over the first suction chamber into the first suction chamber to form a first compartment of the pouch and sucks a second part of the first foil extending over the second suction chamber into the second suction chamber to form a second compartment of the pouch,
   a powder filling device configured to fill the first compartment with a powder,
   a further filling device configured to fill the second compartment with a further powder or a liquid,
   a second foil supplying device configured to position the second foil on the first foil and over the filled first compartment and the filled second compartment in order to from the pouch which holds the powder in the first compartment and the liquid or further powder in the second compartment, and wherein
      the powder filling device comprises;

a housing having a rotor chamber, a chamber inlet and a chamber outlet,

a powder supply to supply the powder to the chamber inlet,

a rotor which is provided in the rotor chamber and comprises multiple dosing cavities in an outer peripheral surface of the rotor, and

a rotor drive configured to rotate the rotor about a rotor axis in a rotor direction in order to receive the powder in the dosing cavities at the chamber inlet and to discharge the powder out of the dosing cavities at the chamber outlet.

The powder filling device is configured to fill the first compartment with the powder in a very accurate manner. Due to this, no or little powder will end up on the first foil located outside the first suction chamber. This is essential because if (too much) powder is located on the parts of the foil covering the support surface of the mould, this has a negative effect on the sealing between the first and second foil. A good sealing is required to avoid that the content of the first and second compartment remain separated from each other and to avoid that the pouches will leak from the first and second compartment to the outside world. In addition to this, it is essential that during the filling of the first compartment, no (or very little) powder ends up in the second compartment in order to avoid contamination.

In an embodiment of the packaging system, the rotor drive is configured to rotate the rotor in a stepwise manner into rotor positions in which a filled dosing cavity is positioned at the chamber outlet.

In an embodiment of the packaging system, the rotor drive is configured to rotate the rotor between rotor positions at a high speed and to stop the rotation of the rotor for a predetermined time period at the rotor positions, or to move the rotor through the rotor positions at a low speed.

In an embodiment of the packaging system, the high speed of the rotor is between, and including, 30 and 120 rounds/minute.

In an embodiment of the packaging system, the low speed of the rotor is larger than 0 and smaller than 5 rounds/minute.

In an embodiment of the packaging system, the dosing cavities are positioned one after the other in the rotor direction.

In an embodiment of the packaging system, the chamber outlet ends at a nozzle having a nozzle opening from which the powder is discharged and the nozzle opening is located along the endless trajectory of the mould.

In an embodiment of the packaging system, the powder filling device is configured to only discharge the powder when the first compartment of the mould is facing the nozzle opening.

In an embodiment of the packaging system, the powder filling device is configured to only discharge the powder when the first compartment of the mould is located right below the nozzle opening.

In an embodiment of the packaging system, the nozzle opening is located at a nozzle distance between, and including, 0.5 and 10 mm from a virtual plane extending through the support surface of the mould when the powder is discharged in the first compartment. The nozzle distance may be 3 mm.

In an embodiment of the packaging system, the chamber outlet extends from the rotor chamber until the nozzle opening and comprises an outlet volume which is the same or larger than a cavity volume of a single dosing cavity.

In an embodiment of the packaging system, the cavity volume of each dosing cavity is between, and including, 5 and 30 cm³.

In an embodiment of the packaging system, the chamber outlet extends downward, preferably in a substantially vertical direction or a vertical direction.

In an embodiment of the packaging system, the rotor chamber is defined by a chamber surface and the outer peripheral surface of the rotor is located at a rotor distance from the chamber surface.

In an embodiment of the packaging system, the rotor distance is between, and including, 0.05 and 0.6 mm. The rotor distance may be 0.3 mm.

In an embodiment of the packaging system, the powder filling device comprises a nozzle member forming the chamber outlet and the nozzle opening, and the nozzle member is attached to the housing such that it pushes against the rotor.

In an embodiment of the packaging system, the nozzle member is mounted to the housing with play and at least one elastic member, such as a spring or a rubber member, is provided which push the nozzle member against the rotor.

In an embodiment of the packaging system, the play of the nozzle member is between, and including, 0.5 and 5 mm. The play may be 1 mm.

In an embodiment of the packaging system, the nozzle member pushes against the outer peripheral surface of the rotor.

In an embodiment of the packaging system, the chamber outlet is defined by an outlet surface which is made of polytertafluoroethylene (Teflon).

In an embodiment of the packaging system, the moulds are first moved along the powder filling device and subsequently along the further filling device.

In an embodiment of the packaging system, the first foil supplying device, the powder filling device, the further filling device, and the second foil supplying device are in the conveying direction located at subsequent positions along the endless trajectory.

In an embodiment of the packaging system, the moulds are first moved along the further filling device and subsequently along the powder filling device.

In an embodiment of the packaging system, the first foil supplying device, the further filling device, the powder filling device, and the second foil supplying device are in the conveying direction located at subsequent positions along the trajectory.

In an embodiment of the packaging system, the mould conveyor is configured to move multiple rows of moulds in the conveying direction along the endless trajectory, the packaging system comprises a row of powder filling devices, and the rotors of the powder filling devices are interconnected and all driven by the same rotor drive.

In an embodiment of the packaging system, the housings of the powder filling devices are separately formed and mounted one after the other along the interconnected rotors.

In an embodiment of the packaging system, the first foil supplying device, the powder filling device, the further filling device, and the second foil supplying device are located at fixed positions along the endless trajectory.

In an embodiment of the packaging system, the second foil supplying device comprises a sealing unit to interconnect the first foil and the second foil.

In an embodiment of the packaging system, the packaging system comprises a cutting device configured to cut the interconnected first foil and second foil in order to form separated pouches.

In an embodiment of the packaging system, the mould conveyor moves the moulds at a constant velocity along the endless trajectory.

In an embodiment of the packaging system, the mould conveyor comprises a drum being rotatable around a drum axis and holding the moulds in a circular configuration around the drum axis, and a drum drive configured to rotate the drum in the conveyor direction around the drum axis in order to move the moulds along the endless trajectory.

In an embodiment of the packaging system, the packaging system comprises a main frame which supports the first foil supplying device, the powder filling device, the further filling device, and the second foil supplying device, the drum moves the moulds along the endless trajectory when positioned in an operating position relative to the main frame, and the drum is supported by a drum frame which can be coupled to the main frame in order to position the drum in the operation position and can be uncoupled from the main frame in order to remove the drum from the packaging system.

### BRIEF DESCRIPTION OF THE DRAWINGS

Embodiments of the packaging system according to the invention will be described by way of example only, with reference to the accompanying schematic drawings in which corresponding reference symbols indicate corresponding parts, and in which:

the FIGS. 1A-C schematically show views in perspective of an embodiment of the packaging system according to the invention,

FIG. 2 schematically shows an enlarged view of part II of FIG. 1C,

FIG. 3A schematically shows a view in perspective of a single row of moulds of the packaging system of FIG. 1,

FIG. 3B schematically shows a top view of the single row of moulds of FIG. 3A,

FIG. 3C schematically shows a view in perspective of the single row of moulds of FIG. 3A,

FIG. 4A schematically shows a front view of the packaging system of FIG. 1,

FIG. 4B schematically shows a rear view of the packaging system of FIG. 1,

FIG. 5 schematically shows an enlarged view of part V of FIG. 4A,

FIG. 6 schematically shows an enlarged view of part VI of FIG. 4A,

FIG. 7 schematically shows an enlarged view of part VII of FIG. 4A,

FIG. 8A schematically shows a view in cross section of the powder filling device of the packaging system of FIG. 1,

FIG. 8B schematically shows an enlarged view of the part VIII of FIG. 8A,

FIG. 9A schematically shows a view in perspective of the powder filling device of the packaging system of FIG. 1,

FIG. 9B schematically shows a first view in cross section of the powder filing device of FIG. 9A,

FIG. 9C schematically shows a first enlarged view of part of FIG. 9A,

FIG. 9D schematically shows a second enlarged view of part of FIG. 9A,

FIG. 9E schematically shows a second view in cross section of the powder filing device of FIG. 9A,

FIG. 9F schematically shows a third view in cross section of the powder filing device of FIG. 9A,

FIG. 10A schematically shows a view in perspective of the interconnected rotors of the powder filing devices of the packaging system of FIG. 1,

FIG. 10B schematically shows a view in perspective of one housing of the powder filing devices of the packaging system of FIG. 1,

FIG. 100 schematically shows a view in perspective of the interconnected rotors and two housings of the powder filing devices of the packaging system of FIG. 1,

FIG. 11 schematically shows a view in cross section of the further filling device of the packaging system of FIG. 1,

FIG. 12 schematically shows a view in cross section of the second foil supplying device and the sealing device of the packaging system of FIG. 1,

the FIGS. 13A-J schematically show operation steps that are performed on one of the moulds of the packaging system of FIG. 1,

the FIGS. 14A-C schematically show views in perspective of the packaging system of FIG. 1,

the FIGS. 15A-C schematically show views in perspective of the drum of the packaging system of FIG. 1, and

the FIGS. 16A and B schematically show views in perspective of the suction device of the packaging system of FIG. 1.

### DETAILED DESCRIPTION OF THE DRAWINGS

FIG. 1A shows a view in perspective of an embodiment of the packaging system 1 according to the invention. The packaging system 1 is configured to produce pouches 2 having multiple compartments and made from a first water-soluble foil 5 and a second water-soluble foil 6.

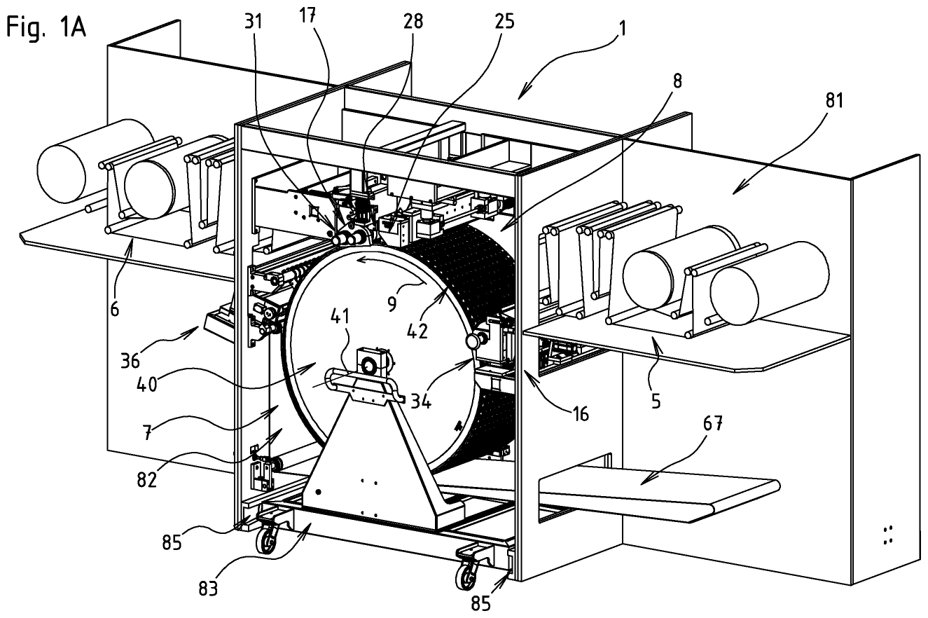

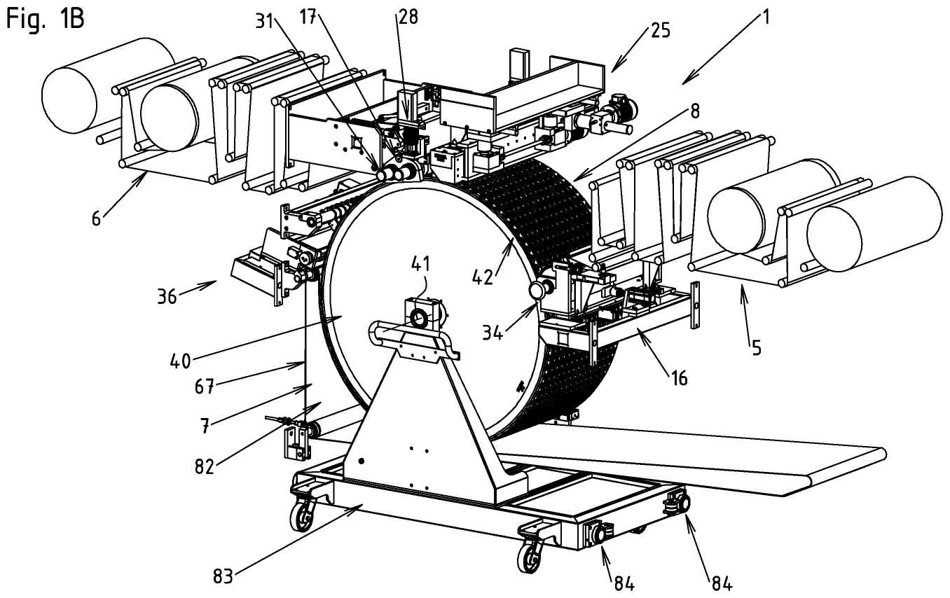

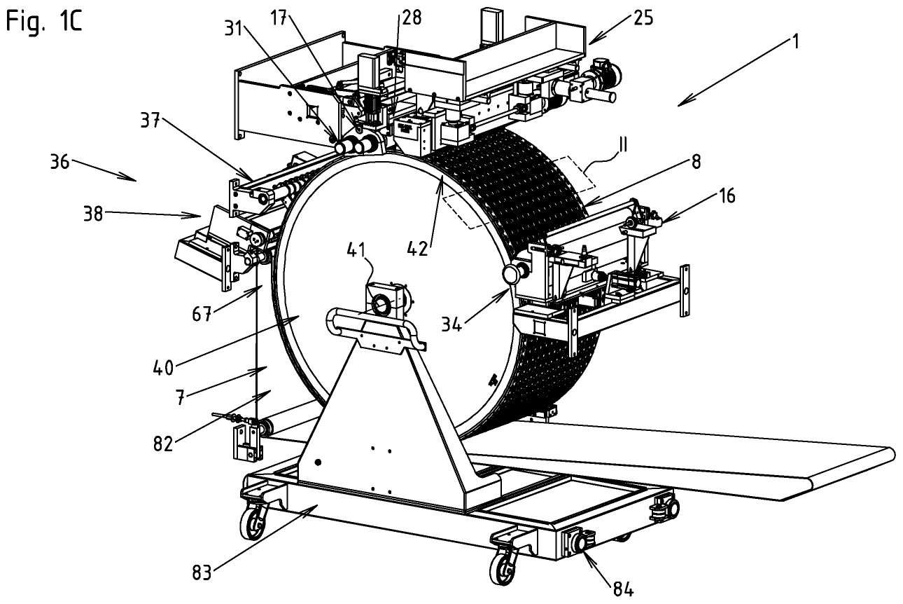

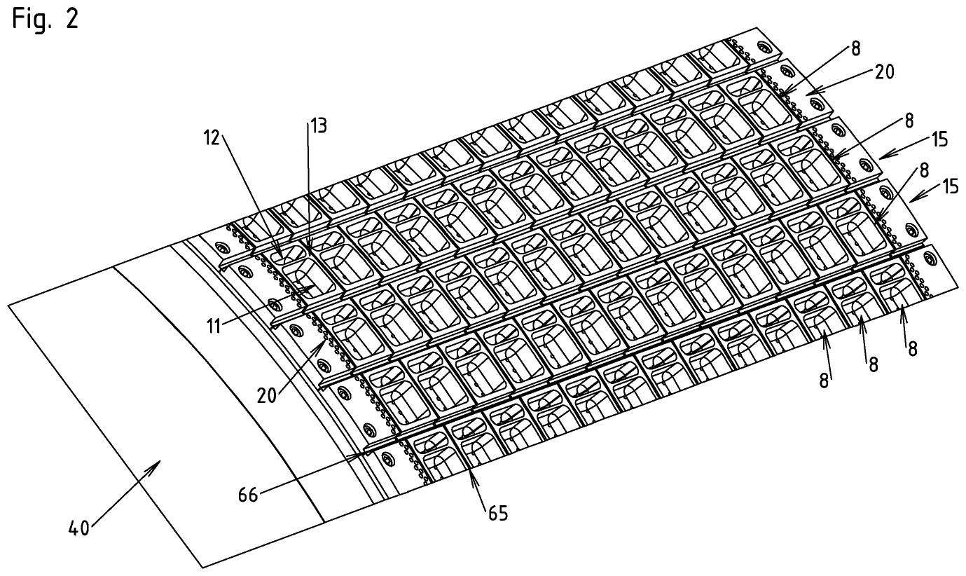

The packaging system 1 comprises a mould conveyor 7 to move multiple moulds 8 in a conveying direction 9 along an endless trajectory 10, more specifically a circular trajectory. The moulds 8 are shown more in detail in FIG. 2. Each mould 8 faces outwards and has a first suction chamber 11, a second suction chamber 12, and a support surface 13 surrounding and extending between the first and second suction chamber 11, 12.

A suction device 14 (see the FIGS. 14-16) is provided to suck the first foil 5 into the first suction chambers 11 and the second suction chambers 12.

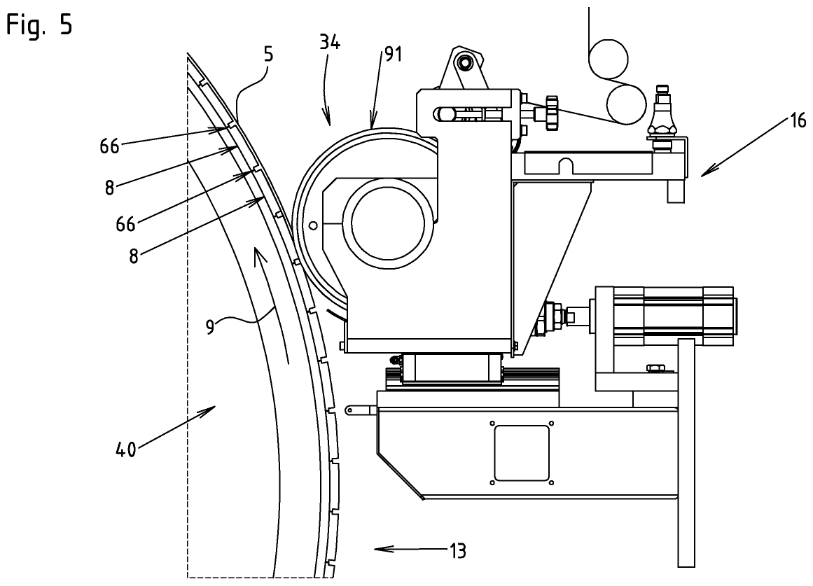

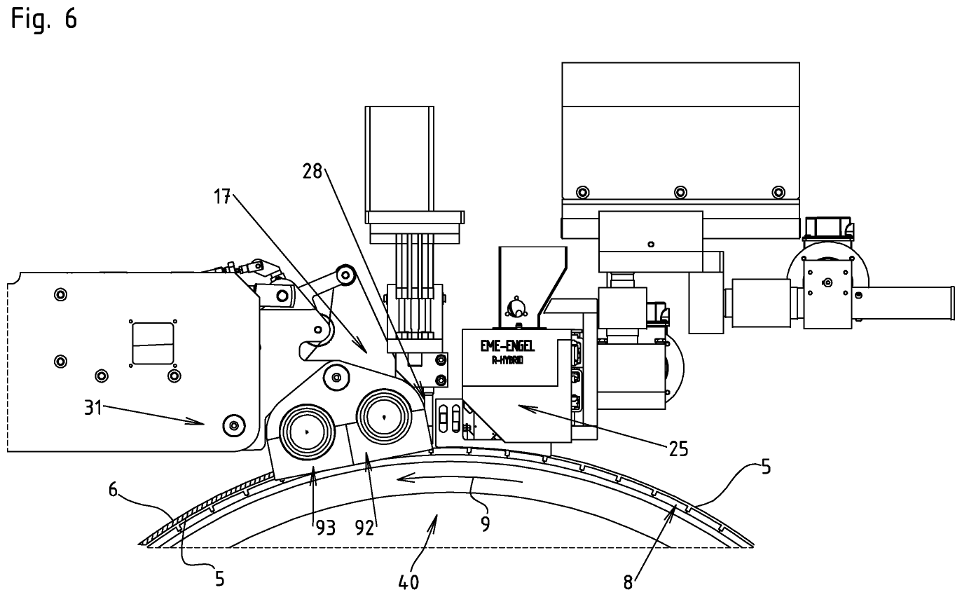

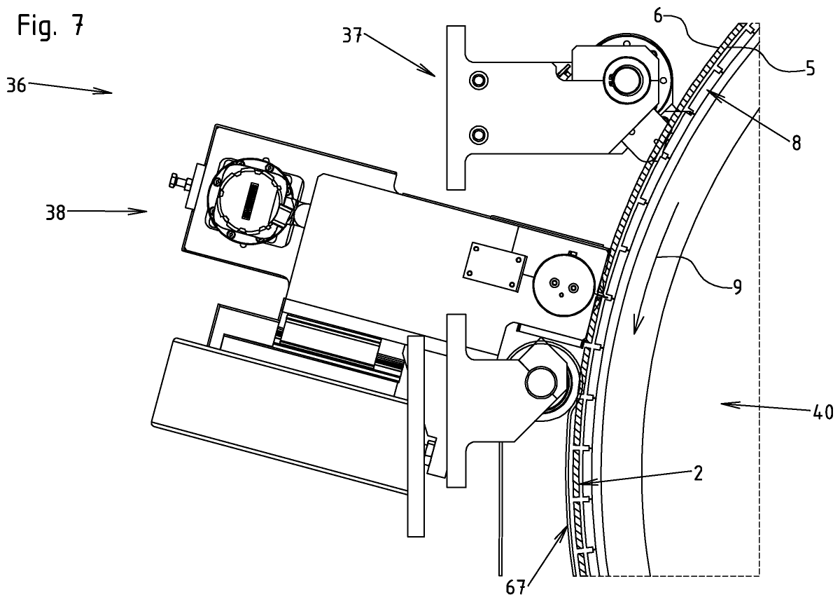

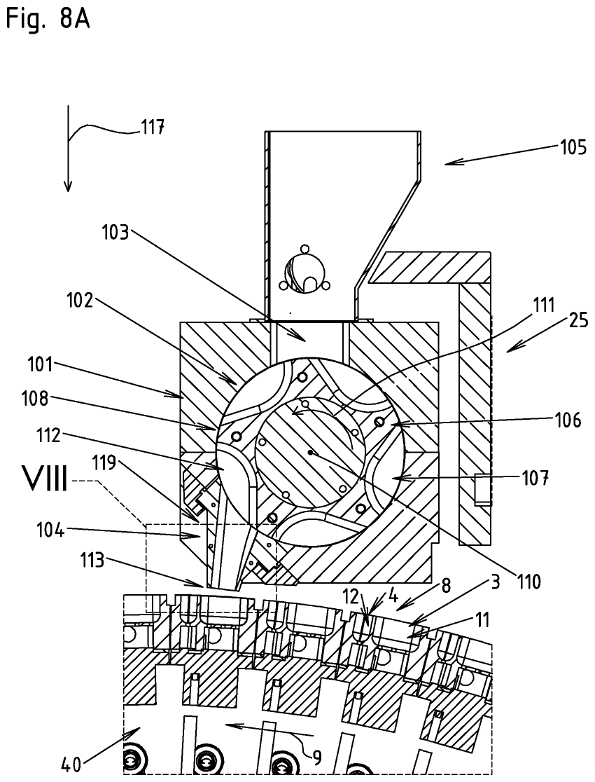

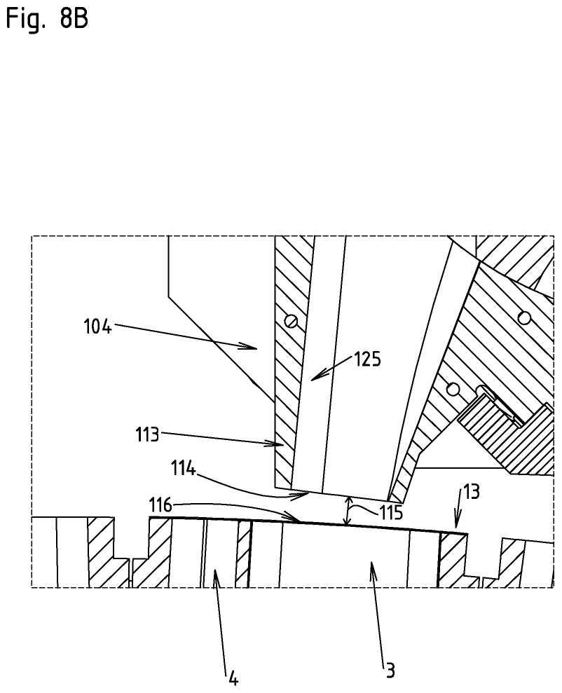

The mould conveyor 7 moves each mould 8 along a first foil supplying device 16 (see FIG. 5), a powder filling device 25 (see the FIGS. 6 and 8), a further filling device 28 (see the FIGS. 6 and 11), a second foil supplying device 17 (see the FIGS. 6 and 12), and a cutting device 36 (see FIG. 7).

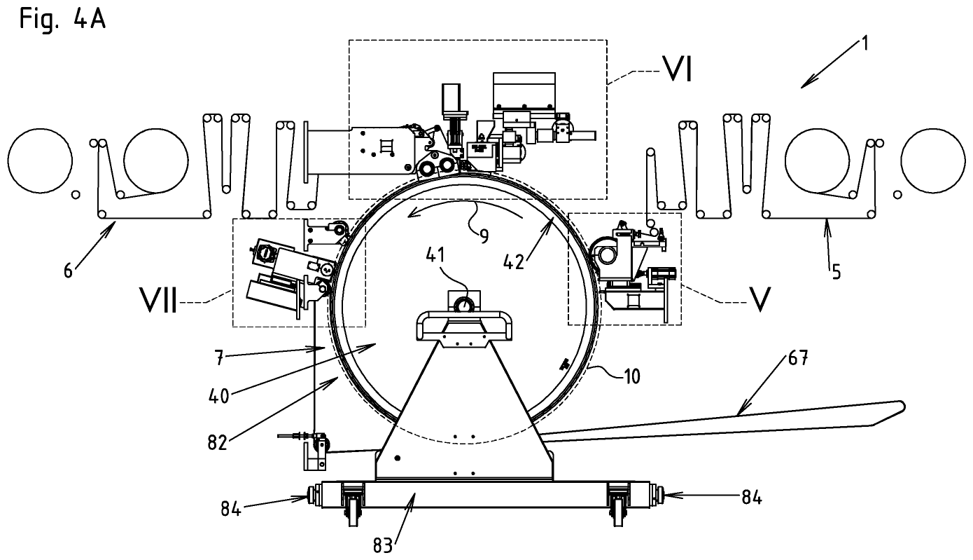

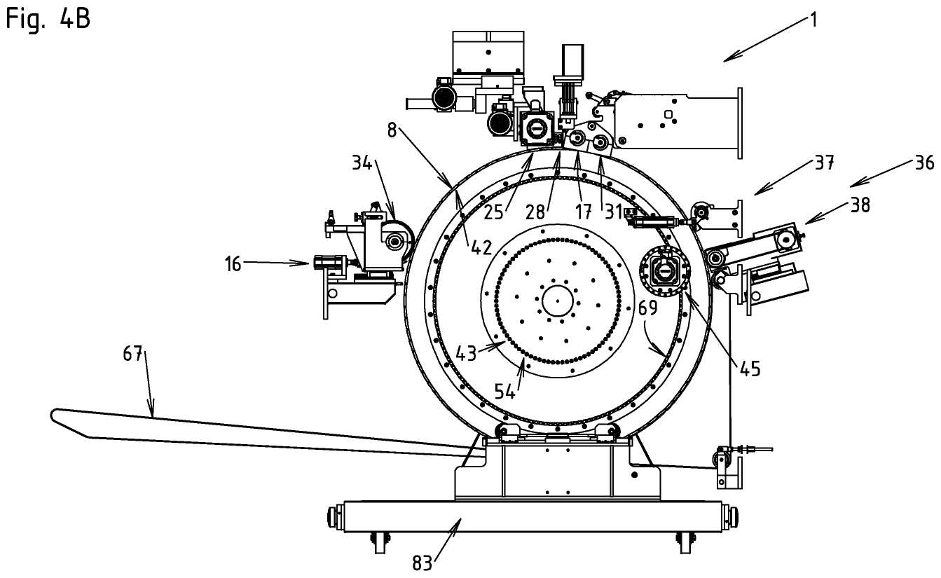

The mould conveyor 7 comprises a drum 40 being rotatable around a drum axis 41 and holding the moulds 8 in a first circular configuration 42 around the drum axis 41. A drum drive 45 configured to rotate the drum 40 in the conveying direction 9 around the drum axis 41 in order to move the moulds 8 along the endless trajectory 10 is provided (see FIG. 4B). The drum 40 allows that the moulds 8 are moved along the endless trajectory 10 in an efficient and stable manner.

The packaging system 1 comprises a main frame 81 which supports the first foil supplying device 16, the powder filling device 25, the further filling device 28, the second foil supplying device 17, and the cutting device 36. The drum 40 moves the moulds 8 along the endless trajectory 10 when positioned in an operating position 82 relative to the main frame 81. The drum 40 is supported by a drum frame 83 which can be coupled to the main frame 81 in order to position the drum 40 in the operating position 82 and can be uncoupled from the main frame 81 in order to remove the drum 40 from the packaging system 1 (see the figures 14A-C). The drum 40 is only supported by the drum frame 83 and not by the main frame 81. This allows that the drum 40 can be installed or removed in a simple and fast manner.

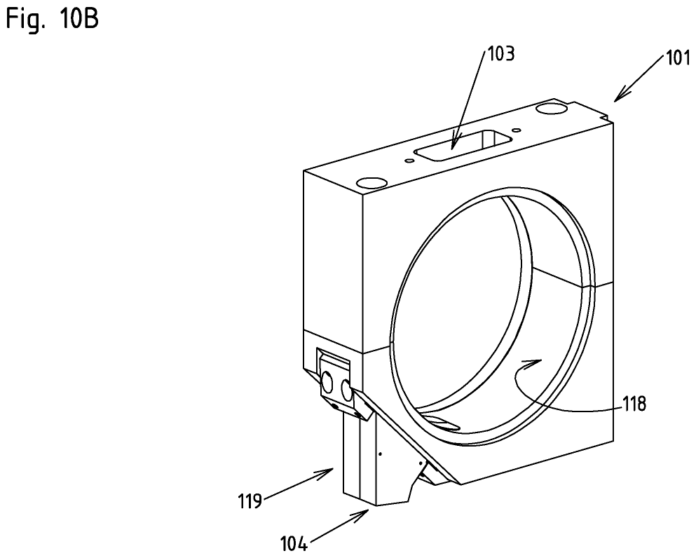

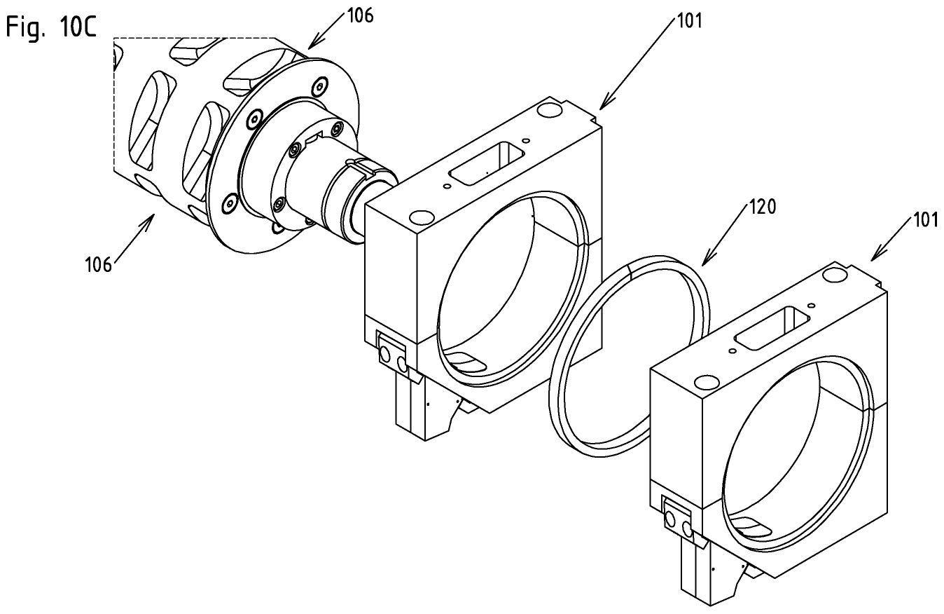

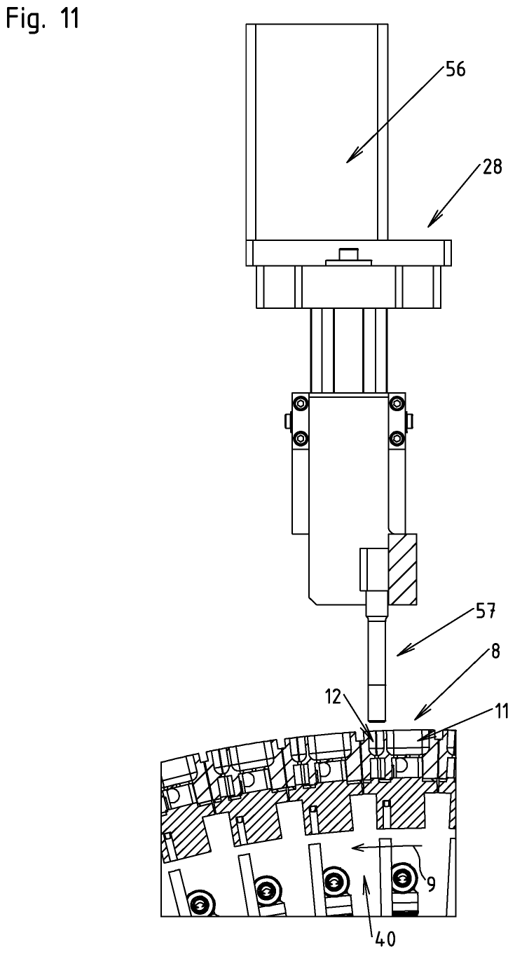

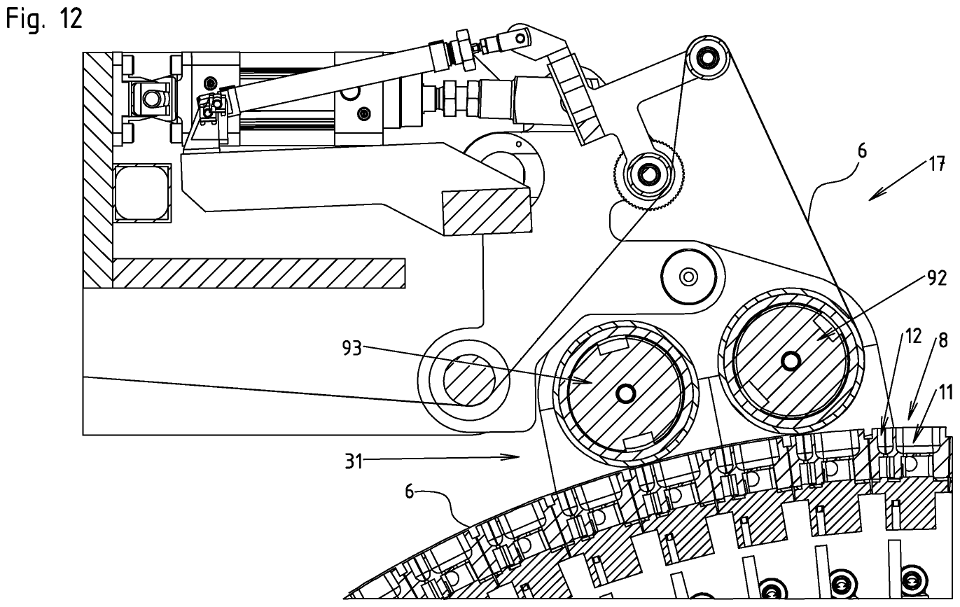

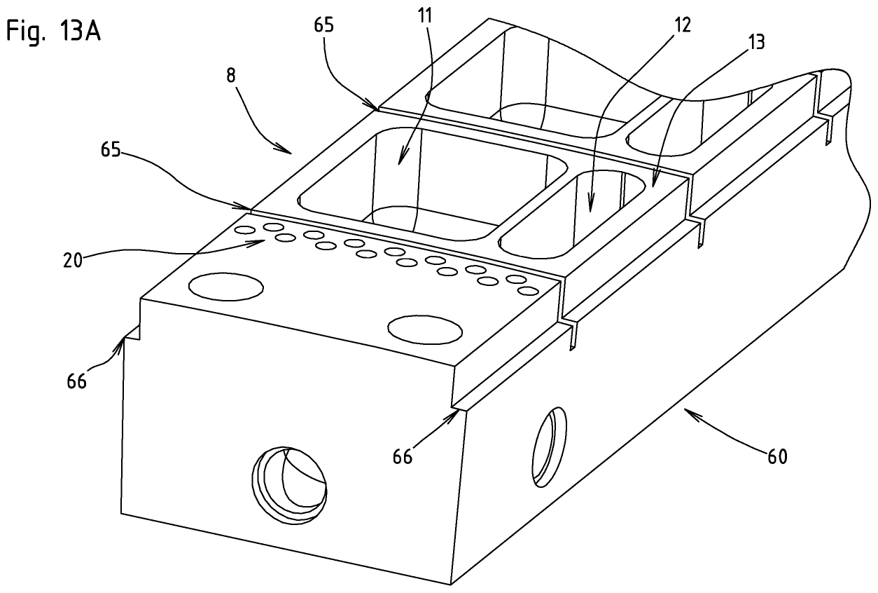

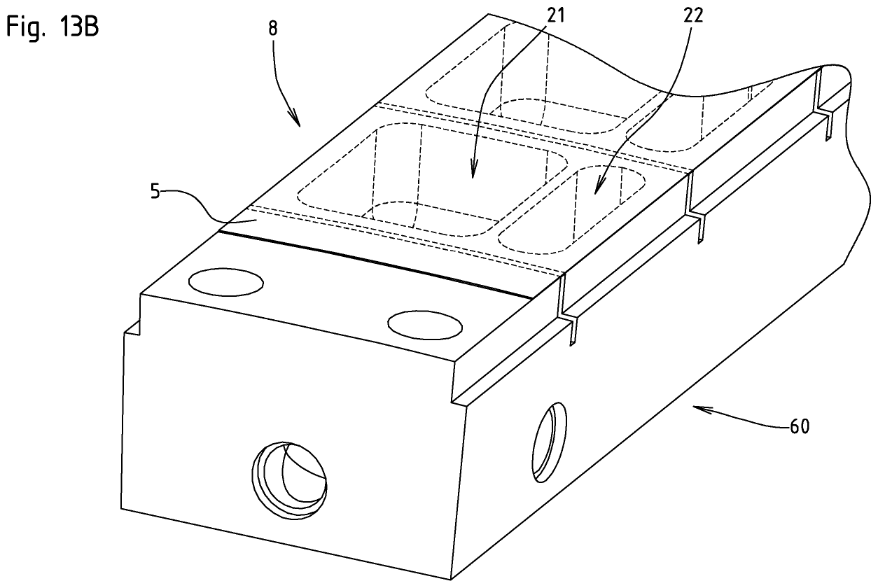

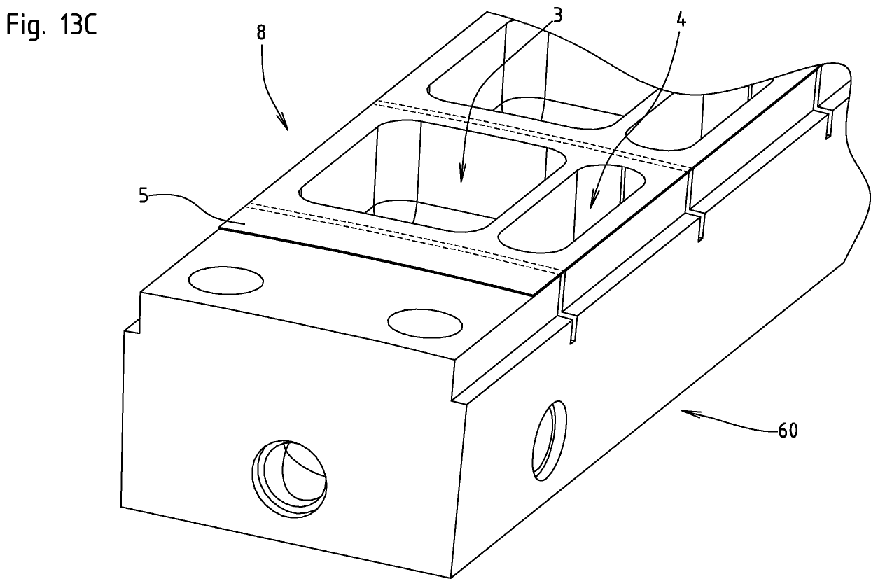

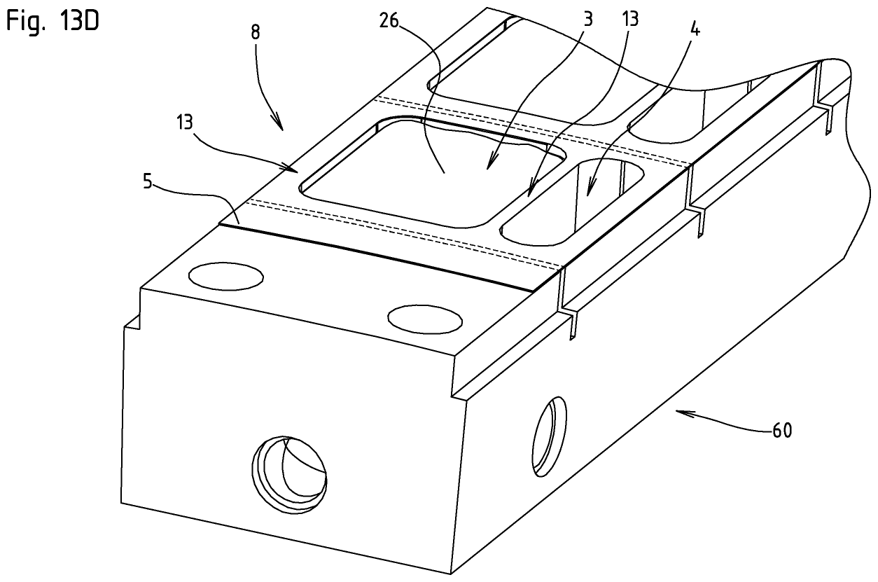

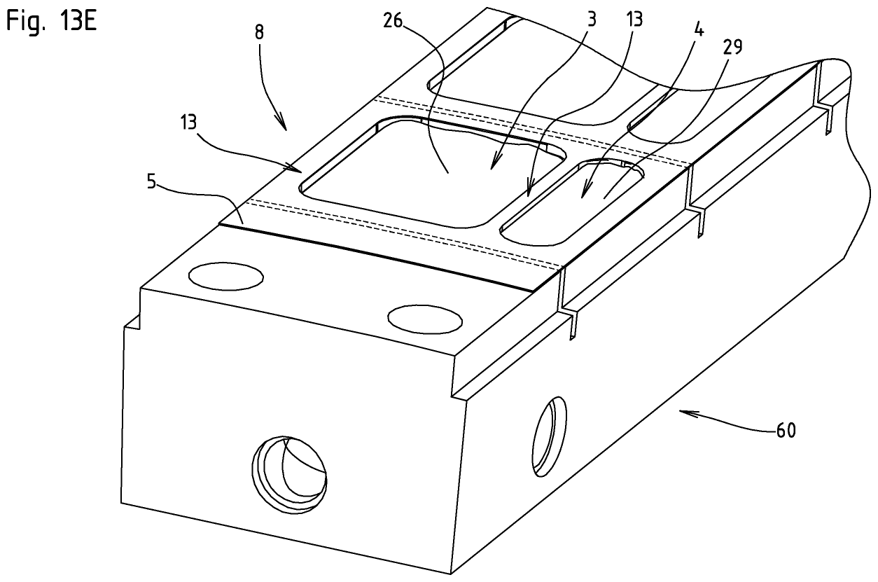

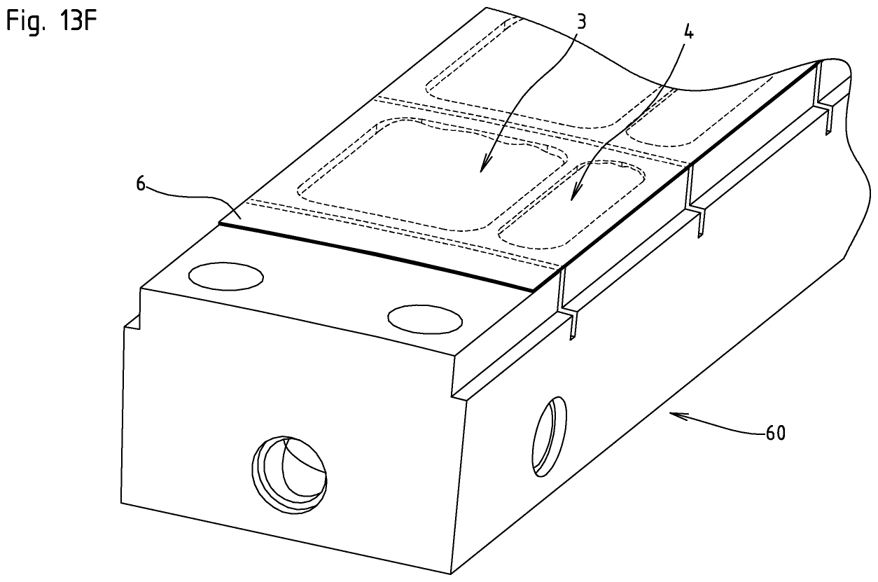

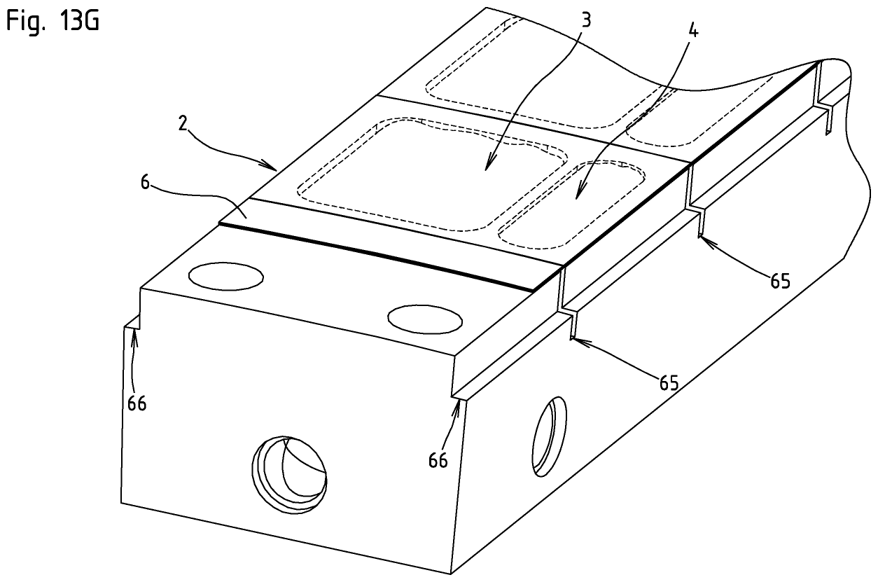

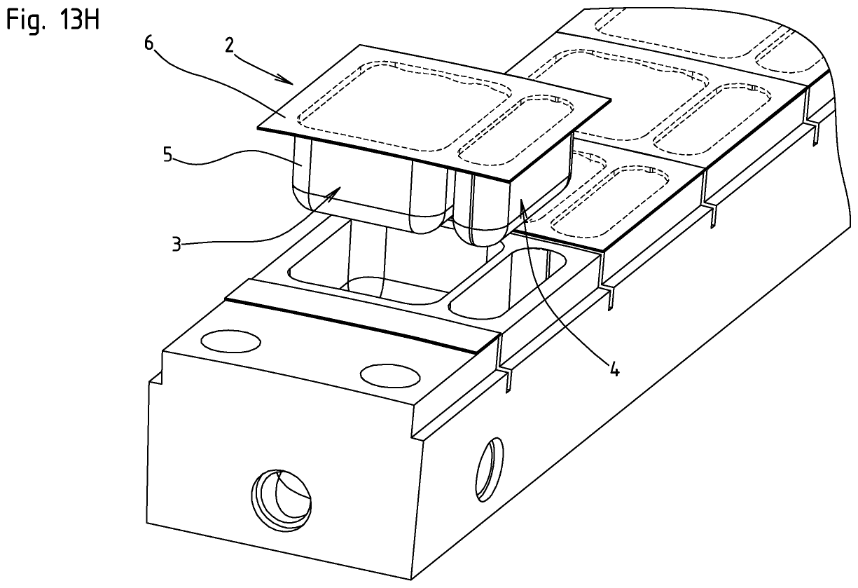

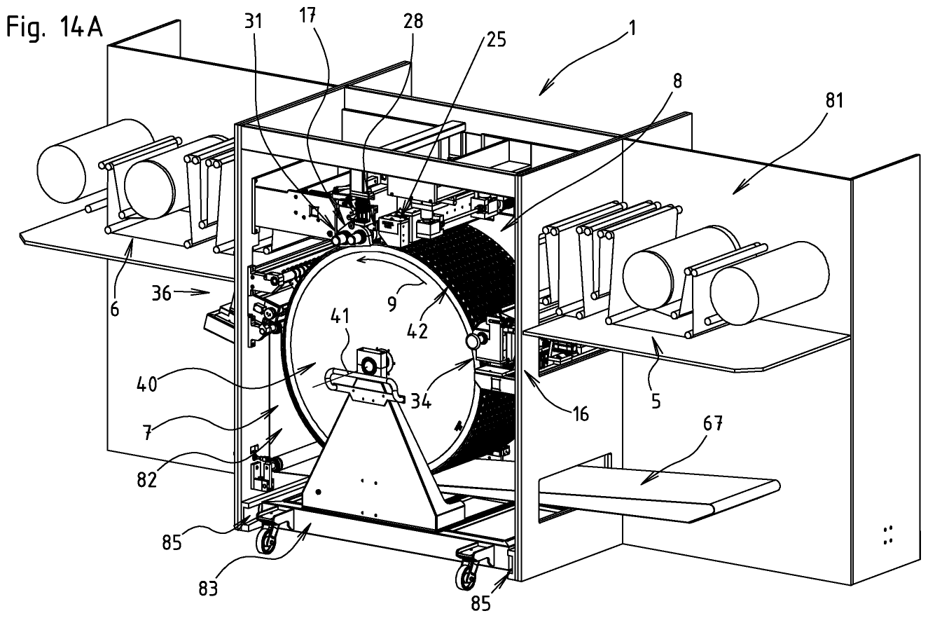

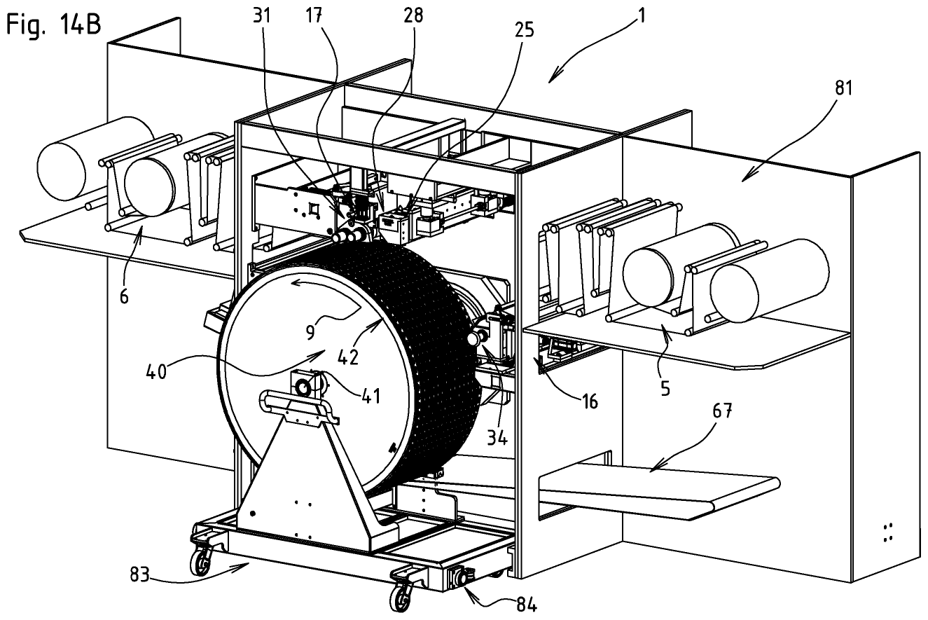

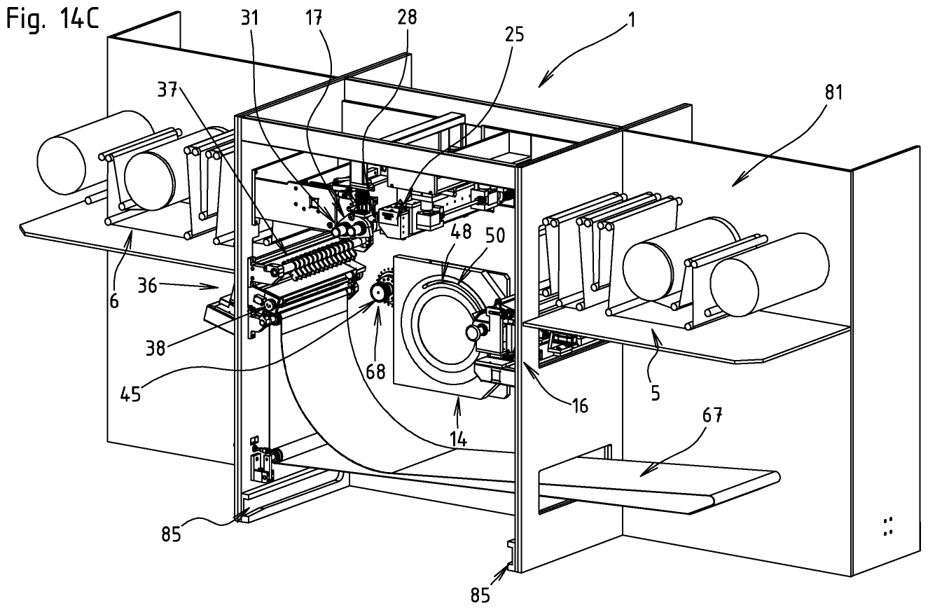

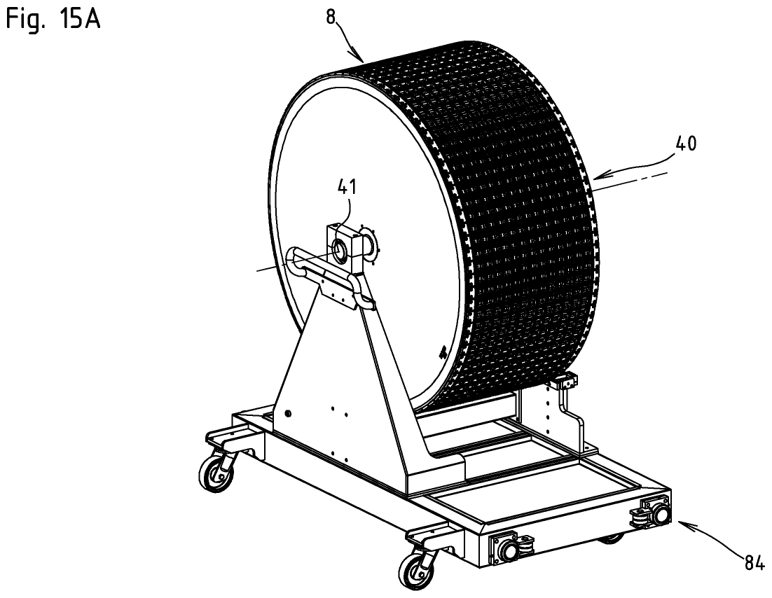

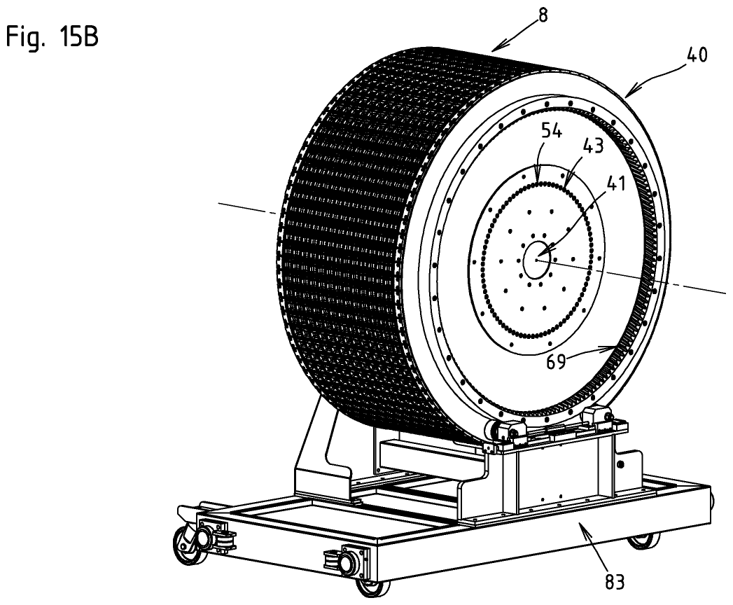

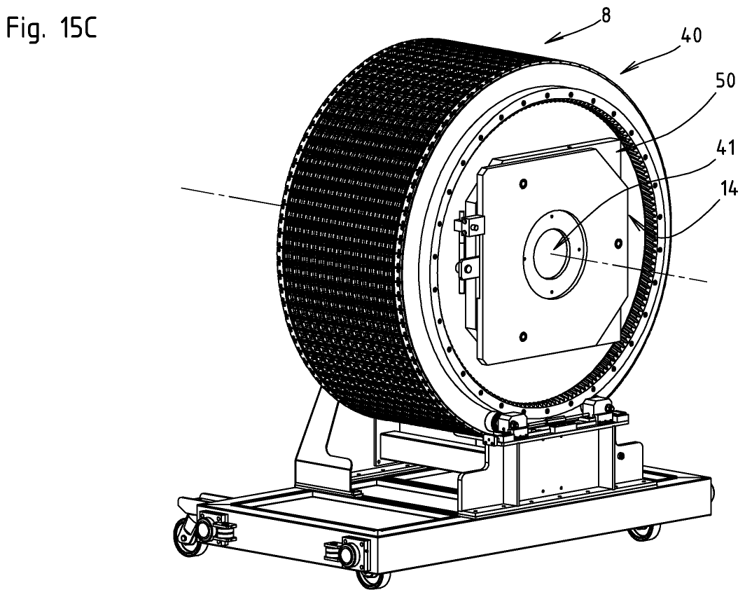

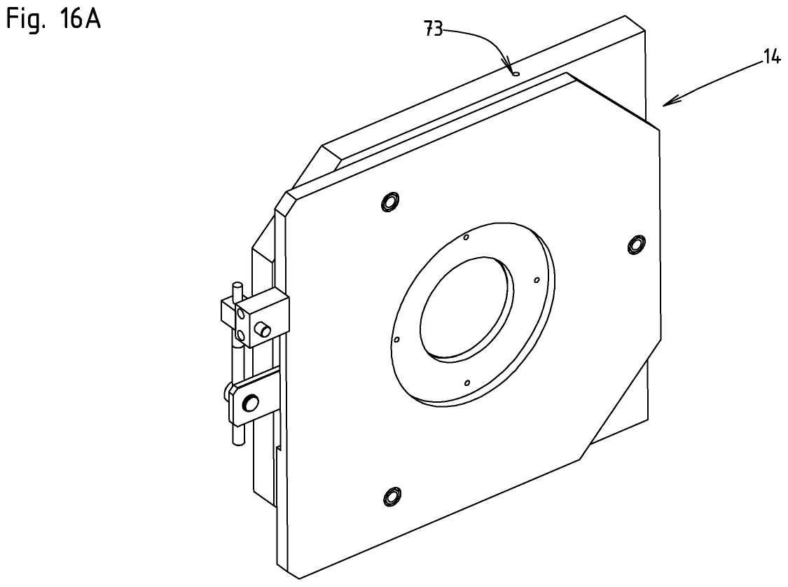

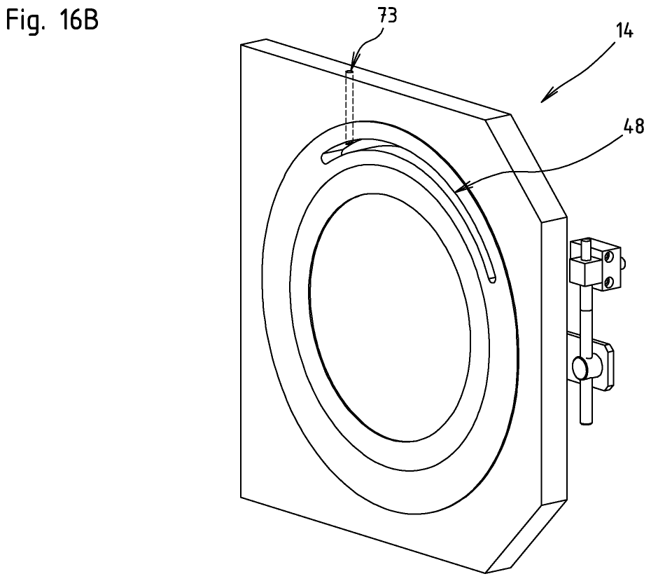

FIG. 2 shows an enlarged view of part II of FIG. 10. The drum 40 of the mould conveyor 7 is provided with rows 15 having thirteen moulds 8. The rows 15 are positioned one after the other in the conveying direction 9 around the drum axis 41. First cutting slits 65 are provided between the different moulds 8 of one row 15 and second cutting slits 66 are provided between the rows 15 of moulds 8.

Each row 15 of moulds 8 comprises fixating suction holes 20 located at the outer sides of the rows 15. These fixating suction holes 20 are used to hold the first foil 5 in position when it is placed on the support surface 13 of the moulds 8 such that it extends over the first and second suction chambers 11, 12. The first foil supplying device 16 will position the first foil 5 such that it covers the fixating suction holes 20 and all the mould 8 located between them.

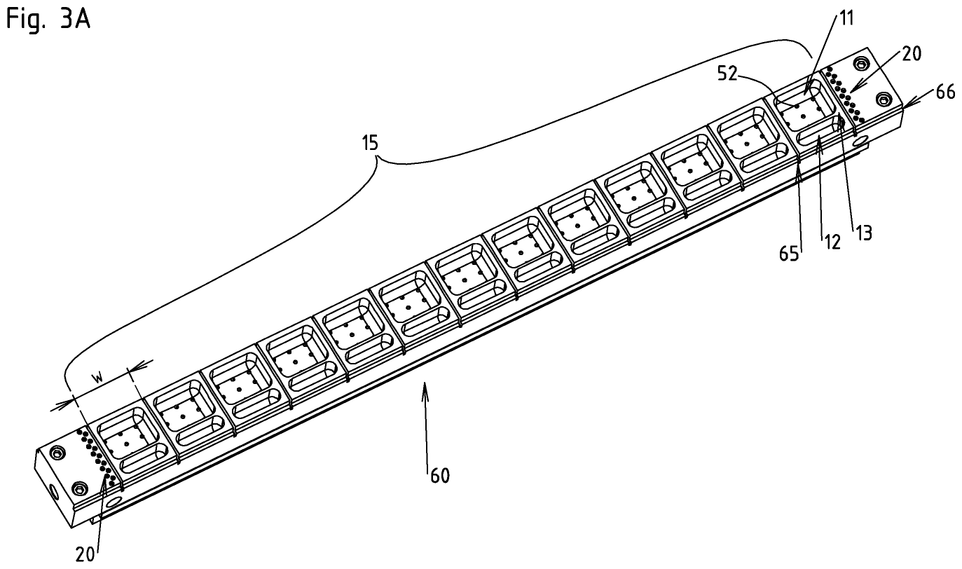

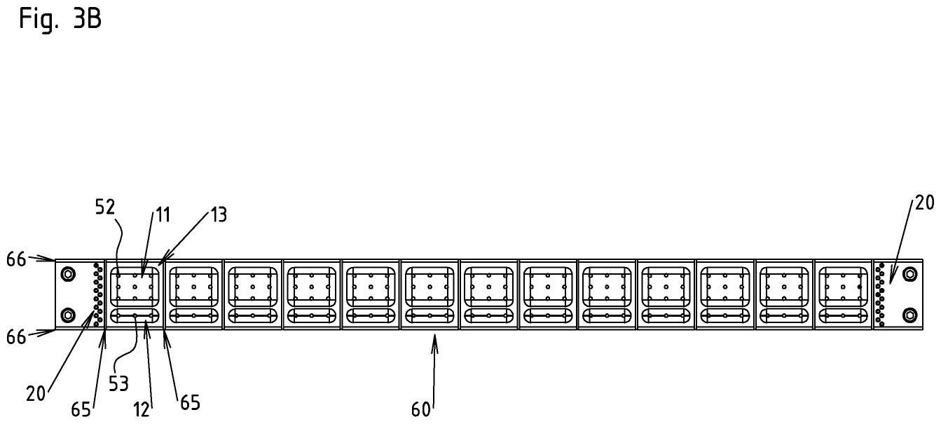

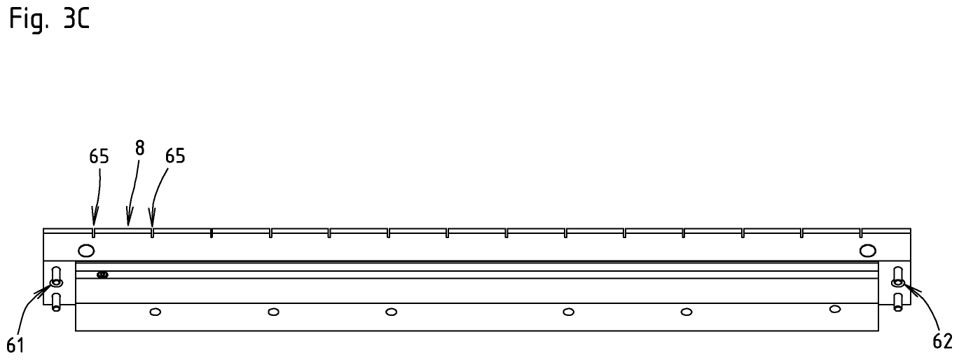

The FIG. 3A-C schematically shows views in perspective of a row member 60 containing a single row 15 of moulds 8. The first suction chambers 11 have first suction openings 52 to suck the first foil 5 into the first suction chambers 11. The second suction chambers 12 have second suction openings 53 to suck the first foil 5 into the second suction chambers 12. The row 15 member 60 comprises a first connector 61 and a second connector 62 to establish fluid communication between the first and second suction openings 52, 53 and the suction device 14. The first and second connector 61, 62 also establish fluid communication between the fixating suction holes 20 and the suction device 14.

The FIGS. 4A and 4B show a front view and a rear view, respectively, of the packaging system 1. Each of the first foil supplying device 16, the powder filling device 25, the further filling device 28, the second foil supplying device 17, and the cutting device 36 is located at a fixed position along the endless trajectory 10.

The first foil supplying device 16, the powder filling device 25, the further filling device 28, the second foil supplying device 17, and the cutting device 36 are in the conveying direction 9 located at subsequent positions along the endless trajectory 10.

FIG. 5 shows an enlarged view of part V of FIG. 4A. This part relates to the first foil supplying device 16 which is configured to position the first foil 5 on the support surface 13 of the mould 8 and over its first and second suction chamber 11, 12 (see FIG. 13B). After that, the suction device 14 will suck a first part 21 of the first foil 5 extending over the first suction chamber 11 into the first suction chamber and a second part 22 of the first foil 5 extending over the second suction chamber 12 into the second suction chamber 12 to form a second compartment 4 of the pouch 2 (see FIG. 13C).

A heating unit 34 is integrated in the first foil supplying device 16 in order to supply the first foil 5 in a heated state. The heating unit 34 comprises a first heated roller 91 which is in contact with the first foil 5 and places the first foil 5 on the moulds 8. The heating of the first foil 5 facilitates the forming of the first and second compartment 3, 4 of the pouch 2.

FIG. 6 shows an enlarged view of part VI of FIG. 4A. This part relates to the powder filling device 25, the further filling device 28, and the second foil supplying device 17.

The powder filling device 25 is configured to fill the first compartment 3 with a powder 26 (see FIG. 13D).

The further filling device 28 is configured to fill the second compartment 4 with a liquid 29 (see FIG. 13E).

The second foil supplying device 17 is configured to position the second foil 6 on the first foil 5 and over the powder 26 in the first compartment 3 and the liquid 29 in the second compartment 4 in order to from the pouch 2 which holds the powder 26 in the first compartment 3 and the liquid 29 in the second compartment 4 (see FIG. 13F).

The second foil supplying device 17 comprises a sealing unit 31 configured to interconnect the first foil 5 and the second foil 6. The sealing unit 31 comprises a second heated roller 92 and a third heated roller 93. After the sealing of the first and second foil 5,6, the pouches 2 are still interconnected.

FIG. 7 shows an enlarged view of part VII of FIG. 4A. The cutting device 36 is configured to cut the interconnected first foil 5 and second foil 6 in order to form separated pouches 2.

The cutting device 36 is located after the second foil supplying device 17 when seen in the conveying direction 9. The cutting device 36 comprises a first cutting unit 37 to cut along the first cutting slits 65 and a second cutting unit 38 to cut along the second cutting slits 66 (see FIG. 13G). After the cutting process, the pouches 2 are separated from each other and can be removed from the mould (see FIG. 13H).

A conveyor belt 67 which covers the complete row 15 of moulds 8 is positioned after the cutting device 36 when seen in the conveying direction 9. The conveyor belt 67 holds the separated pouches 2 in the mould 8 to facilitate a smooth transfer of the pouch 2 on the conveyor belt 67 at a lower part of the drum 40. The conveyor belt 67 subsequently transports the pouches 2 away from the drum 40 (see the FIGS. 4A and 14C).

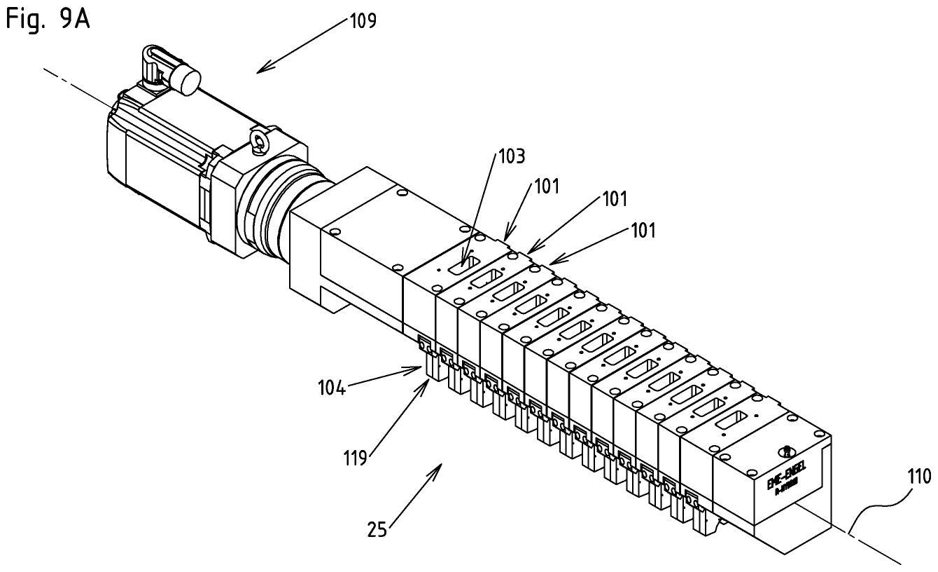

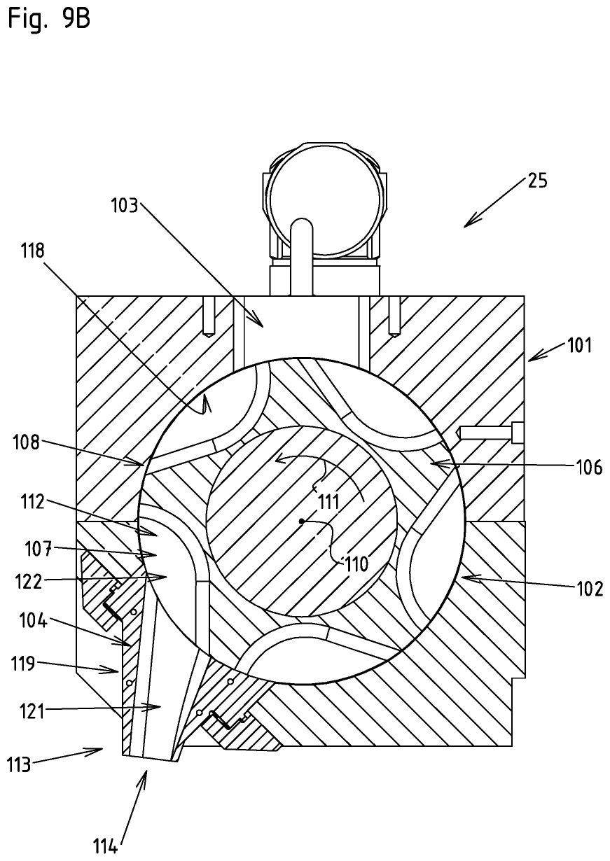

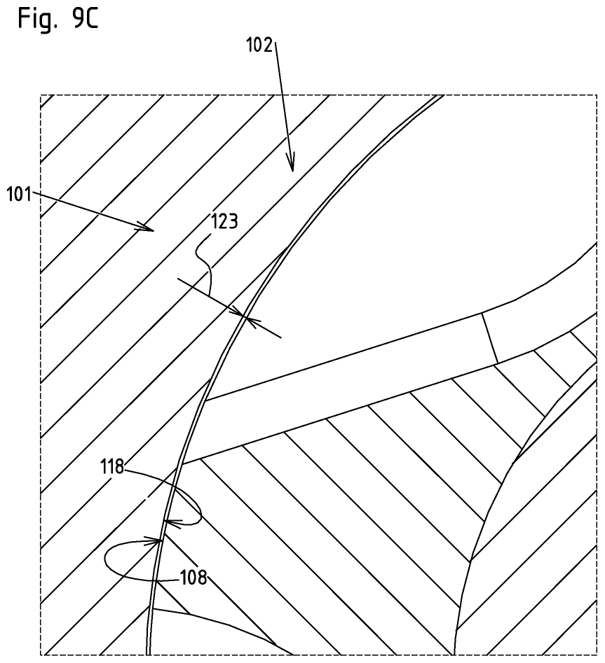

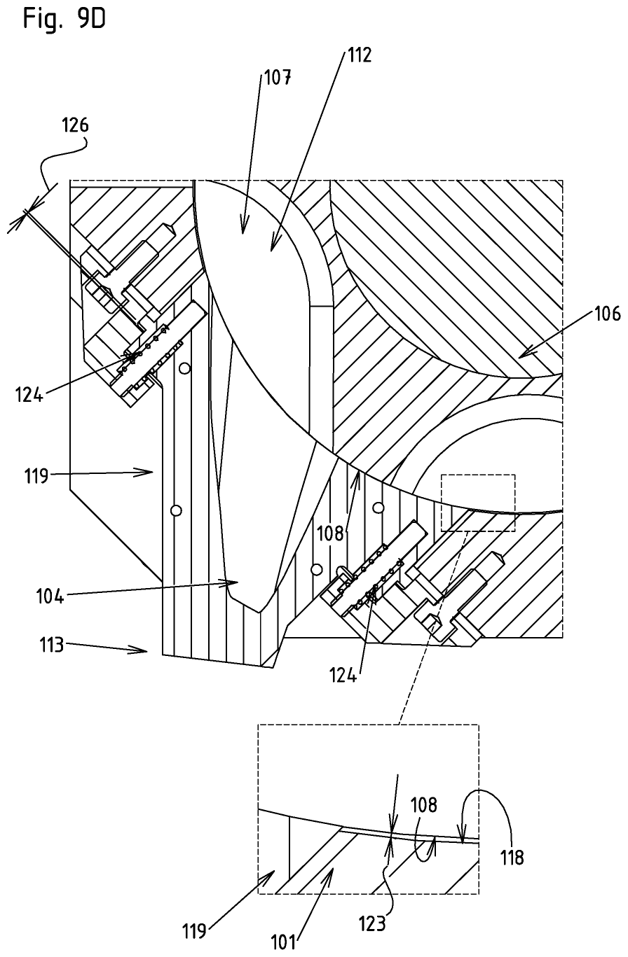

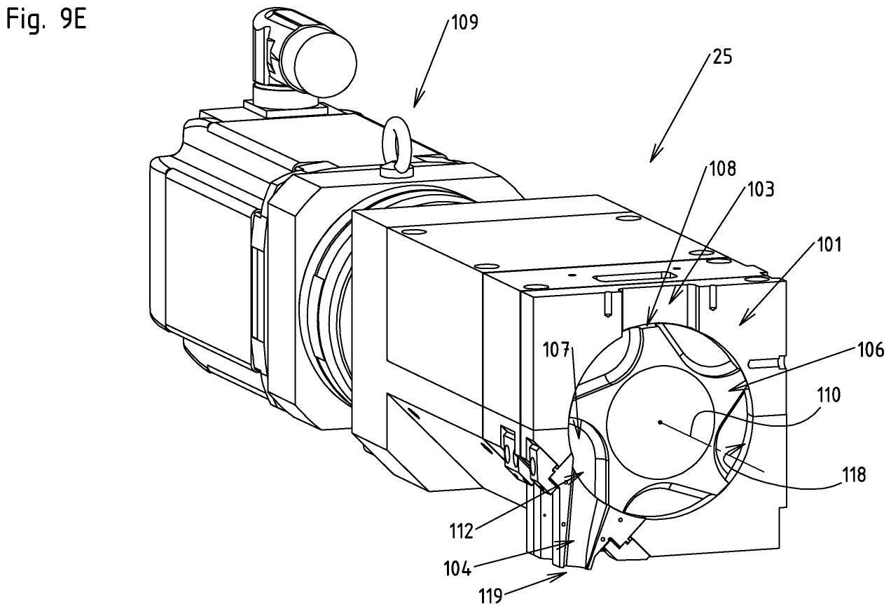

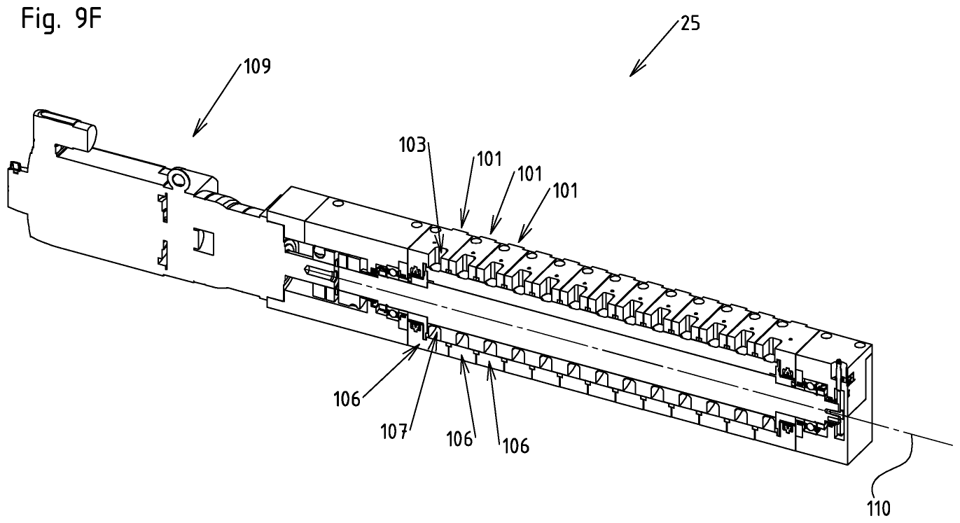

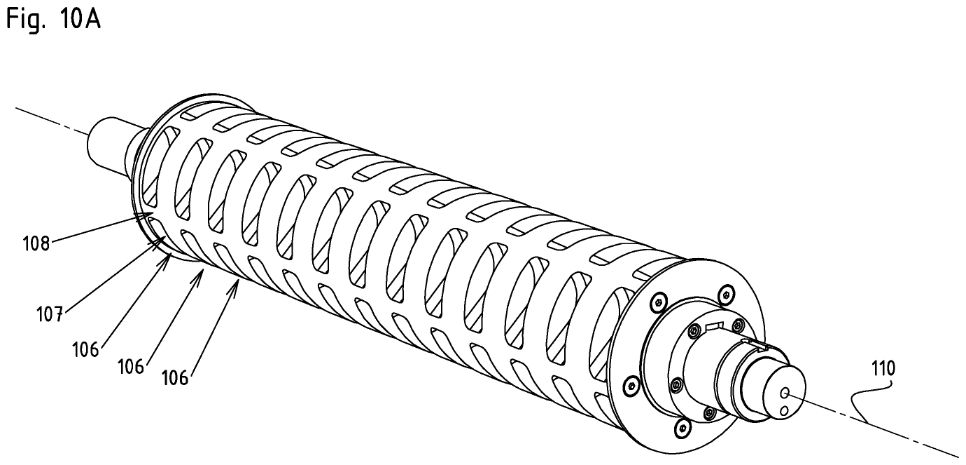

The FIGS. 8A and B show a view in cross section of the powder filling device 25. The powder filling device 25 comprises a housing 101 having a rotor chamber 102, a chamber inlet 103 and a chamber outlet 104, a powder supply 105 to supply the powder 26 to the chamber inlet 103, a rotor 106 which is provided in the rotor chamber 102 and comprises multiple dosing cavities 107 in an outer peripheral surface 108 of the rotor 106, and a rotor drive (109 of FIG. 9A) configured to rotate the rotor 106 about a rotor axis 110 in a rotor direction 111 in order to receive the powder 26 in the dosing cavities 107 at the chamber inlet 103 and to discharge the powder 26 out of the dosing cavities 107 at the chamber outlet 104.

The rotor drive 109 is configured to rotate the rotor 106 in a stepwise manner into rotor positions 112 in which a filled dosing cavity 107 is positioned at the chamber outlet 104. More specifically, the rotor drive 109 is configured to rotate the rotor 106 between rotor positions 112 at a high speed and to stop the rotation of the rotor 106 for a predetermined time period at the rotor positions 112. The high speed of the rotor 106 is between, and including, 30 and 120 rounds/minute.

In another embodiment of the packaging system 1, the rotor drive 109 is configured to rotate the rotor 106 between rotor positions 112 at a high speed and to move the rotor 106 through the rotor positions 112 at a low speed. The low speed of the rotor 106 is larger than 0 and smaller than 5 rounds/minute.

The dosing cavities 107 are positioned one after the other in the rotor direction 109. The chamber outlet 104 ends at a nozzle 113 having a nozzle opening 114 from which the powder 26 is discharged and the nozzle opening 114 is located along the endless trajectory 10 of the mould 8. The powder filling device 25 is configured to only discharge the powder 26 when the first compartment 3 of the mould 8 is facing the nozzle opening 114. The powder filling device 25 is configured to only discharge the powder 26 when the first compartment 3 of the mould 8 is located right below the nozzle opening 114. The nozzle opening 114 is located at a nozzle distance 115 between, and including, 0.5 and 10 mm from a virtual plane 116 extending through the support surface 13 of the mould 8 when the powder 26 is discharged in the first compartment 3.

The chamber outlet 104 extends from the rotor chamber 102 until the nozzle opening 114 and comprises an outlet volume 121 which is the same or larger than a cavity volume 122 of a single dosing cavity 107. The cavity volume 122 of each dosing cavity is between, and including, 5 and 30 cm³. The chamber outlet 104 extends downward, preferably in a (substantially) vertical direction 117.

The FIGS. 9A-F show the powder filling device 25 of FIG. 8. The rotor chamber 102 is defined by a chamber surface 118 and the outer peripheral surface 108 of the rotor 106 is located at a rotor distance 123 from the chamber surface 118 (FIG. 9C). The rotor distance 123 is between, and including, 0.05 and 0.6 mm.

The powder filling device 25 comprises a nozzle member 119 forming the chamber outlet 104 and the nozzle opening 114, and the nozzle member 119 is attached to the housing 101 such that it pushes against the rotor 106 . The nozzle member 119 is mounted to the housing 101 with play 126 and at least one elastic member 124, such as a spring or a rubber member, is provided which push the nozzle member 119 against the rotor 106. The play 126 of the nozzle member 106 is between, and including, 0.3 and 5 mm. The nozzle member 106 pushes against the outer peripheral surface 108 of the rotor 106.

The chamber outlet 104 is defined by an outlet surface 125 which is made of polytertafluoroethylene (Teflon).

The packaging system 1 comprises a row of powder filling devices 25, and the rotors 106 of the powder filling devices 25 are interconnected and all driven by the same rotor drive 109. The housings 101 of the powder filling devices 25 are separately formed and mounted one after the other along the interconnected rotors 106.

FIG. 10A shows the interconnected rotors 106 of the powder filing devices 25. FIG. 10B shows one housing 101 of the powder filing devices 25. FIG. 10C shows the interconnected rotors 106 and two housings 101. As shown in FIG. 10C, a sealing member 120 is provided between neighbouring housings 101.

FIG. 11 shows a view in cross section of the further filling device 28. The further filling device 28 comprises a liquid supply 56 which feeds the liquid 29 to a liquid outlet 57. The further filling device 28 is configured to discharge a dose of liquid 29. In the situation shown, the second suction chamber 12, in which the second compartment 4 of the first foil 5 (not shown) is located, is positioned under the liquid outlet 57 to receive the dose of liquid 29. The further filling device 28 only discharges liquid from the liquid outlet 57 when the second suction camber 12 is located right under the liquid outlet 57.

In a further embodiment of the packaging system 1 according to the invention, the further filling device 28 is configured to fill the second compartment 4 with a second powder.

In the shown embodiment of the packaging system 1 according to the invention, the moulds 8 are first moved along the powder filling device 25 and subsequently along the further filling device 28. In said situation, the first foil supplying device 16, the powder filling device 25, the further filling device 28, and the second foil supplying device 17 are in the conveying direction 9 located at subsequent positions along the endless trajectory 10.

In a further embodiment of the packaging system 1 according to the invention, the moulds 8 are first moved along the further filling device 28 and subsequently along the powder filling device 25. In said situation, the first foil supplying device 16, the further filling device 28, the powder filling device 25, and the second foil supplying device 17 are in the conveying direction 9 located at subsequent positions along the trajectory 10.

FIG. 12 shows a view in cross section of the second foil supplying device 17. The second heated roller 92 of the sealing unit 31 is in contact with the second foil 6 and places the second foil 6 on the first foil 5 (not shown). The heat of the second heated roller 92 already takes care of part of the sealing process. The third heated roller 93 rolls over the second foil 6 in order to finish the sealing process.

The FIGS. 13A-H show operation steps that are performed on one of the moulds 8. FIG. 13A shows one mould 8 of the row 15 of FIG. 3. Said mould 8 is moved along the endless trajectory 10 by the mould conveyor 7, more specifically the drum 40. In FIG. 13B, the first foil 5 is positioned on the support surface 13 of the mould 8 and over its first and second suction chamber 11, 12 by the first foil supplying device 16. After that, the first part 21 of the first foil 5 is sucked into the first suction chamber 11 to form the first compartment 3 of the pouch 2 and the second part 22 of the first foil 5 is sucked into the second suction chamber 12 to form the second compartment 4 of the pouch 2 (FIG. 13C).

The powder filling device 25 is used to fill the first compartment 3 with the powder 26. Due to the accurate filling by the powder filling device 25, no or little powder 26 will end up on the first foil 5 located outside the first suction chamber 11. This is essential because if (too much) powder is located on the parts of the foil covering the support surface 13 of the mould 8, this has a negative effect on the sealing between the first and second foil 5, 6. A good sealing is required to avoid that the content of the first and second compartment 3, 4 remain separated from each other and to avoid that the pouches will leak from the first and second compartment 3, 4 to the outside world. In addition to this, it is essential that during the filling of the first compartment 3, no (or very little) powder 26 ends up in the second compartment 4 in order to avoid contamination.

The further filling device 28 is used to fill the second compartment 4 with the liquid 29 (FIG. 13E).

In FIG. 13F, the second foil 6 is positioned on the first foil 5 and over the powder 26 in the first compartment 3 and the liquid 29 of the second compartment 4 by the second foil supplying device 17. The seal between the first foil 5 and the second foil 6 is created by the sealing unit 31 which is integrated in the second foil supplying device 17. The first cutting unit 37 and the second cutting unit 38 of the cutting device 36 make subsequently the cuts along the first cutting slits 65 and the second cutting slits 66, respectively (FIG. 13G).

In FIG. 13H, the pouch 2 holding the powder 26 in the first compartment 3 and the liquid 29 in the second compartment 4 is removed from the mould 8.

The FIGS. 14A-C show views in perspective of the packaging system 1. In FIG. 14A, the drum 40 is located in the operating position 82 relative to the main frame 81. In FIG. 14B, the drum 40 is partly removed from the packaging system 1. In FIG. 14C, the drum 40 is completely removed from the packaging system 1. The drum drive 45 is visible. The drum drive 45 comprises a gear wheel 68 which engages a gear rack 69 (see FIG. 15B) provided on the drum 40. Also the suction device 14 is shown.

The FIGS. 15A-B show views in perspective of the drum 40. The drum 40 is only supported by the drum frame 83. The drum frame 83 comprises first coupling members 84 which can be coupled with cooperating second coupling members 85 connected to the main frame 81 when the drum 40 is positioned in the operating position 82. The coupled first and second coupling members 84, 85 hold the drum 40 in the operating position 82.

The drum 40 is provided with drum suction openings 54 located in a second circular configuration 43 (FIG. 15B). Each drum suction opening 54 is in fluid communication with the first and second connector of row 15 of moulds 8. In FIG. 15C, also the suction device 14 is shown. The suction device 14 is positioned relative to the drum 40 as it would when the drum 40 is located in the operating position 82.

The FIGS. 16A and 16B show the suction device 14. The suction device 14 comprises a suction mouth 48 which is in fluid communication with a low pressure via a fluid duct 73. In use, the suction device 14 is located at a fixed suction position 50 relative to the drum axis 41. The drum suction openings 54 are positioned to be received by the suction mouth 48 when the drum 40 is rotated. The first and second suction chambers 11, 12 of each row 15 of moulds 8 are in fluid communication with one of the drum suction openings 54. For each row 15 of mould 8 its suction opening 54 is positioned relative to the suction mouth 48 such that said suction opening 54 is received by the suction mouth 48 after said row 15 of moulds 8 has passed the first foil supplying device 16 and before said mould has reached the powder filling device 25.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the device and method without departing from the scope as defined in the claims.

1-30. (canceled)

31. A packaging system for producing pouches having multiple compartments and made from a first water-soluble foil and a second water-soluble foil, which packaging system comprises:
a mould conveyor to move multiple moulds in a conveying direction along an endless trajectory, such as a circular trajectory, wherein each mould faces outwards and has a first suction chamber, a second suction chamber, and a support surface surrounding and extending between the first and second suction chamber;
a suction device configured to suck the first foil into the first suction chambers and the second suction chambers, and wherein the mould conveyor moves each mould along;
a first foil supplying device configured to position the first foil on the support surface of the mould and over its first and second suction chamber, after which the suction device sucks a first part of the first foil extending over the first suction chamber into the first suction chamber to form a first compartment of the pouch and sucks a second part of the first foil extending over the second suction chamber into the second suction chamber to form a second compartment of the pouch;
a powder filling device configured to fill the first compartment with a powder;
a further filling device configured to fill the second compartment with a further powder or a liquid;
a second foil supplying device configured to position the second foil on the first foil and over the filled first compartment and the filled second compartment in order to from the pouch which holds the powder in the first compartment and the liquid or further powder in the second compartment, and wherein
the powder filling device comprises:
a housing having a rotor chamber, a chamber inlet and a chamber outlet;
a powder supply to supply the powder to the chamber inlet;
a rotor which is provided in the rotor chamber and comprises multiple dosing cavities in an outer peripheral surface of the rotor; and
a rotor drive configured to rotate the rotor about a rotor axis in a rotor direction in order to receive the powder in the dosing cavities at the chamber inlet and to discharge the powder out of the dosing cavities at the chamber outlet.

32. The packaging system according to claim 31, wherein the rotor drive is configured to rotate the rotor in a stepwise manner into rotor positions in which a filled dosing cavity is positioned at the chamber outlet.

33. The packaging system according to claim 31, wherein the rotor drive is configured to rotate the rotor between rotor positions at a high speed and:
to stop the rotation of the rotor for a predetermined time period at the rotor positions;
or to move the rotor through the rotor positions at a low speed.

34. The packaging system according to claim 33, wherein the high speed of the rotor is between, and including, 30 and 120 rounds/minute.

35. The packaging system according to claim 33, wherein the low speed of the rotor is larger than 0 and smaller than 5 rounds/minute.

36. The packaging system according to claim 31, wherein the dosing cavities are positioned one after the other in the rotor direction.

37. The packaging system according to claim 31, wherein the chamber outlet ends at a nozzle having a nozzle opening from which the powder is discharged and the nozzle opening is located along the endless trajectory of the mould.

38. The packaging system according to claim 37, wherein the powder filling device is configured to only discharge the powder when the first compartment of the mould is facing the nozzle opening.

39. The packaging system according to claim 37, wherein the powder filling device is configured to only discharge the powder when the first compartment of the mould is located right below the nozzle opening.

40. The packaging system according to claim 37, wherein the nozzle opening is located at a nozzle distance between, and including, 0.5 and 10 mm from a virtual plane extending through the support surface of the mould when the powder is discharged in the first compartment.

41. The packaging system according to claim 37, wherein the chamber outlet extends from the rotor chamber until the nozzle opening and comprises an outlet volume which is the same or larger than a cavity volume of a single dosing cavity.

42. The packaging system according to claim 41, wherein the cavity volume of each dosing cavity is between, and including, 5 and 30 cm³.

43. The packaging system according to claim 31, wherein the rotor chamber is defined by a chamber surface and the outer peripheral surface of the rotor is located at a rotor distance from the chamber surface.

44. The packaging system according to claim 43, wherein the rotor distance is between, and including, 0.05 and 0.6 mm.

45. The packaging system according to claim 37, wherein the powder filling device comprises a nozzle member forming the chamber outlet and the nozzle opening, and the nozzle member is attached to the housing such that it pushes against the rotor.

46. The packaging system according to claim 45, wherein the nozzle member is mounted to the housing with play and at least one elastic member, such as a spring or a rubber member, is provided which pushes the nozzle member against the rotor.

47. The packaging system according to claim 46, wherein the play of the nozzle member is between, and including, 0.3 and 5 mm.

48. The packaging system according to claim 45, wherein the nozzle member pushes against the outer peripheral surface of the rotor.

49. The packaging system according to claim 31, wherein:
the mould conveyor is configured to move multiple rows of moulds in the conveying direction along the endless trajectory;
the packaging system comprises a row of powder filling devices; and
the rotors of the powder filling devices are interconnected and all driven by the same rotor drive.

50. The packaging system according to claim 49, wherein the housings of the powder filling devices are separately formed and mounted one after the other along the interconnected rotors.
